(19) United States
(12) Patent Application Publication
(10) Pub. No.: US 2019/0019197 A1
(43) Pub. Date: Jan. 17, 2019

(54) DETERMINING TO DISPATCH A TECHNICIAN FOR CUSTOMER SUPPORT

(71) Applicant: ASAPP, INC, New York, NY (US)

(72) Inventors: Denisa Anca Olteanu Roberts, New York, NY (US); Shawn Henry, Brooklyn, NY (US); Hui Dai, New York, NY (US)

(21) Appl. No.: 15/649,061

(22) Filed: Jul. 13, 2017

(51) Int. Cl. G06Q 30/00; G06Q 10/06; G06N 3/04; G10L 15/26; G10L 15/22

(52) U.S. Cl. CPC G06Q 30/016; G06Q 10/063112; G10L 15/22; G06N 3/04; G10L 15/265; G06Q 10/067

(57) ABSTRACT

Mathematical models may be used to improve the customer support process by using a dispatch model to determine whether to dispatch a technician and/or an analysis model to determine one or more actions to be taken to resolve the customer support issue. The mathematical models may process a feature vector that includes features relating to text of the customer support request and other information such as the operational status of the service provided to the customer. A dispatch model may process the feature vector to determine whether to dispatch a technician and an analysis model may process the feature vector to select one or more actions to be performed by the technician or another person. Influential features may be identified and used to provide additional information relating to decision or selections of the mathematical models.

### FIELD OF THE INVENTION

The present invention relates to using mathematical models to determine whether to dispatch a technician for customer support purposes.

### BACKGROUND

Companies may provide services to customers where the customers use the services in their houses or another location, such as for business purposes. Examples of such services include Internet, television, phone, electricity, gas, water, and security services. The customer may call the company for support relating to the service, such as the service not working correctly or not working at all. The cause of the problem may occur in a variety of places, such as inside the customer's house, outside the customer's house and near the customer's house, inside a facility operated by the company (e.g., a data center), or at a location not close to either the customer's house or a facility operated by the company (e.g., a downed wire).

The solution to some problems may be remedied by assisting the customer to perform operations in his house (e.g., restarting a device). The solution to some problems may be remedied by dispatching a technician to the customer's house to perform an operation either inside the customer's house or outside the customer's house. The solution to some problems may be remedied in other manners, such as the company taking action in a facility owned by the company or dispatching a technician to another location.

Dispatching a technician to a customer's house may be an expensive operation since the company needs to pay for the cost of the technician's time to travel to the customer's house and diagnose and fix the problem. In some situations, a technician may be dispatched to the customer's house where the problem could have been easily fixed by the customer on his own or the problem is not at the customer's house and thus the technician is not able to fix the problem there. A company may be able to lower its expenses and provide improved customer support by making better decisions regarding the likely cause of a problem and when to dispatch a technician.

### BRIEF DESCRIPTION OF THE FIGURES

The invention and the following detailed description of certain embodiments thereof may be understood by reference to the following figures:

FIG. 1 is an example system where a company provides a service to a customer.

FIG. 2 is a flowchart of an example implementation of using one or more mathematical models to determine whether to dispatch a technician and/or diagnose a customer support problem.

FIGS. 3A and 3B are flowcharts of an example implementation of determining influential features.

FIGS. 4A and 4B are example systems making a decision or selection and determining influential features in making the decision or selection.

FIG. 5 is an example system for training a dispatch model or an analysis model.

FIG. 6 is an exemplary computing device that may be used to determine whether to dispatch a technician, select one or more actions to be performed to respond to a customer support request, or determine influential features relating to responding to a customer support request.

### DETAILED DESCRIPTION

Described herein are techniques for diagnosing problems relating to services provided to a customer and determining when to dispatch a technician to a location of the customer to fix a problem with the service. The techniques described herein may apply to any service provided to a customer where an aspect of the service travels from one location to a location of the customer. The travel of the service may include a tangible transfer (e.g., water or gas), a wired transfer (e.g., electrical, Internet, television), wireless transfer (e.g., satellite Internet or television), or any other kind of transfer. Examples of such services include but are not limited to Internet, television, phone, electricity, gas, water, and security services. The techniques described herein may also apply to any service that relates to a person going to the home of the customer to perform an action for a customer, such as sending a person to repair an appliance previously purchased by the customer. The services may be provided to any appropriate location, such as a home of the customer, a business location of the customer, or the current physical location of the customer (e.g., the customer is personally at a particular latitude and longitude).

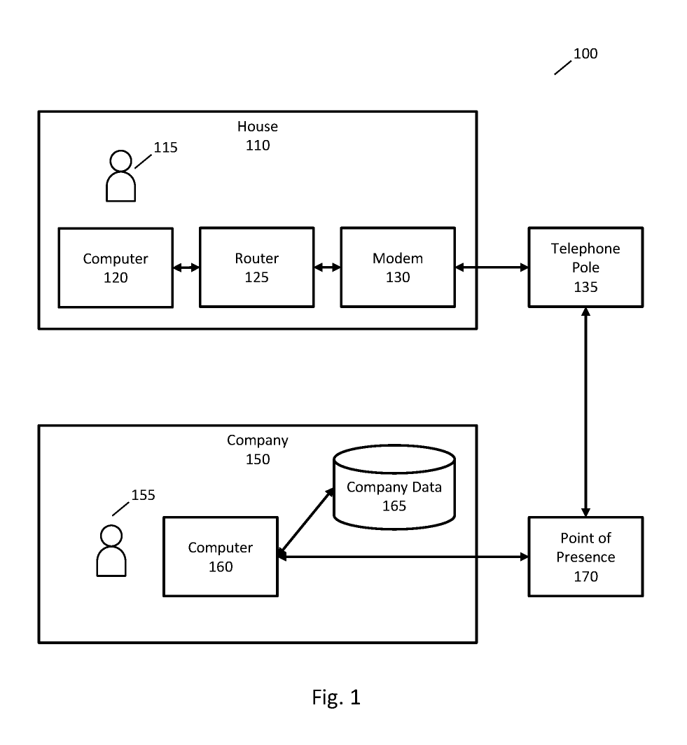

FIG. 1 is an example system 100 where a company provides Internet service to the house of a customer. This particular service has been selected for clarity of presentation, but the techniques described herein apply to any appropriate service provided to any appropriate location.

In FIG. 1, company 150 is providing Internet service to customer 115 at his house 110. In providing the Internet service, data may be transferred over a variety of locations before being ultimately used by customer 115. For example, where the customer requests a web page, a point of presence 170 of company 150 may receive the data for the web page from another location (e.g., the web server that provides the web page). Company may then transmit the web page data to the customer's house 110 and the web page data may be transmitted by wires attached to telephone poll 135. A wire from telephone poll 135 may be connected to modem 130 in the customer's house 110. Modem 130 may in turn be connected to router 125 (e.g., a Wi-Fi router), which is in turn connected to computer 120 that is used by customer 115.

Customer 115 may occasionally have a problem with the Internet service, for example the service may be slow or not work at all. When customer 115 is having a problem, he may contact company for customer support. Customer 115 may contact company 150 using any appropriate techniques (e.g., text message, online customer support chat, phone, etc.) and the customer support may be provided by a person (a customer support representative or CSR) or may be automated in that responses are provided by computer algorithms.

In the example of FIG. 1, customer 115 is receiving assistance from CSR 155. CSR 155 may have access to computer 160 to allow CSR 155 to assist customer 115. Using computer 160, CSR 155 may have access to a variety of sources of information to assist customer 115. For example, CSR 155 may be able to determine the status of devices in the customer's house 110 (e.g., modem 130 or router 125), obtain information about the status of the service provided to customer 115 (e.g., by obtaining information from point of presence 170), access information about the customer's account from company data store 165, access trouble shooting trees to help diagnose the problem, or access any other relevant information source.

To diagnose the customer's problem and determine whether to dispatch a technician to the customer's house, one or more mathematical models may be used to process available information and output a classification decision. Any appropriate information may be input to the mathematical models and any appropriate mathematical models may be used, such as the information and models described herein.

Information that may be processed includes information about the operational status of the service provided to the customer, such as any of the following: information about an event (a “service health event”) that impacted the provision of the service to one or more customers (e.g., downed wire or problem in data center); text describing the operational status of the service or a service health event (e.g., obtained from a report provided by a technician); a time of resolution of service health event; a dispatch of a technician to assist a customer with a problem relating to a service health event; a severity of a service health event; a number of residences and/or businesses affected by a service health event; an amount of time to resolve the system health event; or whether a department responsible for the service issued a ticket to resolve the service health event.

Information that may be processed includes information obtained from technicians who have been dispatched to customer locations to assist with a problem, such as any of the following: a written report by a technician; a survey completed by a technician (e.g., multiple choice); previous technician visits to the location of the customer currently requesting assistance; or technician visits to other customers, such as customers who are geographically close to a customer currently requesting assistance.

Information that may be processed includes information obtained from a customer account, such as the following: whether the customer is residential or business; whether the customer performed an operation during a time period (e.g., installed a new modem in the past 30 days); or services received by the customer.

Information that may be processed includes information about a customer's recent interactions with the company, such as the following: how many times the customer has contacted (e.g., chat or call) customer service during a time period (e.g., the past 30 days); whether a contact request was answered; whether a customer support session was abandoned by the customer; a location of the CSR assisting the customer; an amount of time since the contact request; the reason for the contact request (e.g., payment, equipment malfunction, etc.); the service relating to the contact request (e.g., Internet, television, etc.); a duration of a support session; or the text or audio of the support session.

The above information may be processed to create features for input into one or more mathematical models, such as a feature vector of features. As used herein, a feature vector includes any format for storing features for processing by a model, such as a matrix of features. Individual features may take any appropriate format such as booleans, integers, real numbers, word counts, a 1-of-k vector, or an n-of-k vector (a vector of length k with a true value in n elements and false values in other elements). A 1-of-k vector may be a vector of length k with a true value in one element and false values in other elements to indicate which of the k options occurred (e.g., a reason for a support request). An n-of-k vector may be a vector of length k with a true value in n elements and false values in other elements to indicate n of possible k options (e.g., services received by the customer).

Accordingly, when customer 115 contacts company 150 for customer support a feature vector may be created using any of the information described above. This feature vector may then be processed by one or more mathematical models to assist in diagnosing the customer's problem.

In some implementations, a single mathematical model may be used. For example, the single mathematical model may process the feature vector and output a vector of length N, where each element of the vector corresponds to a possible problem or an action to be taken to resolve a problem, and each element of the vector contains a score indicating how likely it is that the corresponding problem is present. For example, the output vector may contain elements corresponding to “reset modem”; “replace modem”; “check connection from telephone pole to house”; and so forth. An action may be selected using the output vector, such as selecting an action having a highest score. After selection of an action, the decision to dispatch a technician may be based on the selected action. For example, some actions may require a technician to be dispatched (e.g., “check connection from telephone pole to house”) and some actions may not need a technician (e.g., “reset modem”).

In some implementations, more than one mathematical model may be used. For example, a first mathematical model may be a dispatch model that processed a feature vector and outputs a value (e.g., a score or a boolean) indicating whether a technician should be dispatched to the customer's location, and a second mathematical model may be an analysis model that processes a feature vector (may be the same feature vector as processed by the dispatch model or a different feature vector) and outputs values indicating an action that should be taken to assist the customer, such as a vector of scores where each element corresponds to an action. The dispatch model and analysis model may be processed in either order.

In some implementations, a dispatch model may be used to determine whether to dispatch a technician. If it is decided to dispatch a technician, then a first analysis model may be used to determine an action for the technician to perform. If it is decided not to dispatch a technician, then a second analysis model may be used to determine an action to be performed (e.g., by the customer or the CSR). In some implementations, multiple analysis models may be used. For example, a directed graph or tree may be created where each node of the tree corresponds to an action and the tree may be traversed using the multiple analysis models. At each node of the tree, the analysis model may be used to determine whether to stay at the current node or traverse to a child node of the current node. Any of the techniques described in U.S. patent application Ser. No. 15/254,008, filed on Sep. 1, 2016 and incorporated by reference in its entirety, may be used to determine an action using a directed graph and analysis models.

After a decision whether to dispatch a technician has been determined and one or more actions selected, they may be used to assist the customer. For example, where it is decided to dispatch a technician, one or more of the following procedures may be performed: the customer may be notified that a technician will be dispatched and the customer may schedule an appointment (either automatically or with the assistance of a CSR), the customer may be informed of one or more actions that are likely to be performed, and the technician may be informed of the one or more actions that are likely to be performed. Informing the technician in advance of the actions to be performed may help the technician prepare in advance for the visit so the technician has any needed supplied and brings the needed supplies with him to the customer's house.

Where it is decided not to dispatch a technician, the customer may be assisted remotely by the CSR or via an automatic process. For example, the CSR may be informed of the one or more actions and guide the customer in performing those actions or the customer may receive automated messages instructing the customer to perform the one or more actions.

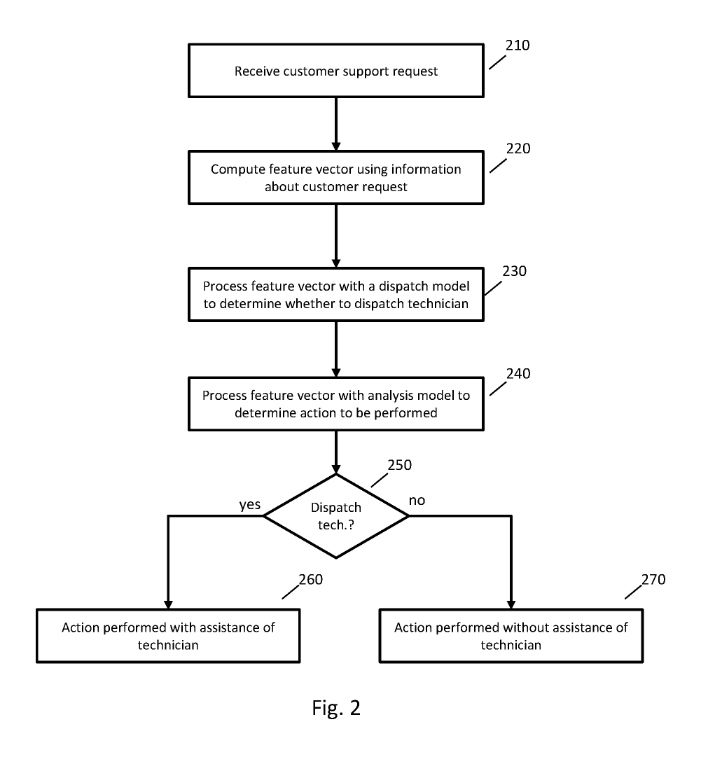

FIG. 2 is a flowchart of an example implementation of using one or more mathematical models to determine whether to dispatch a technician and/or diagnose a customer support problem. In FIG. 2, the ordering of the steps is exemplary and other orders are possible, not all steps are required, and, in some implementations, some steps may be omitted or other steps may be added. The process of the flowcharts may be implemented, for example, by any of the computers or systems described herein.

At step 210, a customer support request is received. The request may be received using any of the techniques described herein. For example, the request may be a message containing text or voice, the request may be received by an automated process or by a CSR, and the request may be made using any appropriate device (e.g., smartphone, desktop computer, etc.) or application (SMS, email, smartphone app, etc.).

At step 220, a feature vector is computed using the customer support request. The feature vector may include any of the features described herein, such as an intent computed from text of the customer support request (e.g., obtained from a text message or performing automatic speech recognition on a speech signal).

As step 230, the feature vector may be processed with a dispatch model to determine whether to dispatch a technician to resolve the customer support request, and at step 240, the feature vector (or a different feature vector) is processed with an analysis model to determine one or more actions to be performed to resolve the problem relating to the customer support request. An action may include either a possible cause of the problem (e.g., the modem is functioning incorrectly) or an action to be performed to fix the problem (e.g., the modem needs to be replaced). In some implementations, steps 230 and 240 may be performed in a single step with a single model or may be performed with more than two models, such as multiple analysis models.

At step 250, if it is determined to dispatch a technician, then processing proceeds to step 260, where the action is performed with the assistance of a technician. For example, one or both of the customer and a technician may be informed of the one or more actions to be performed, a technician visit may be scheduled, and the technician may perform the one or more actions at the location of the customer.

At step 250, if it is determined not to dispatch a technician, then processing proceeds to step 270, where the action is performed without the assistance of a technician. For example, one or both of a customer and CSR may be informed of the one or more actions, the customer may perform the actions, and/or the CSR may assist the customer remotely in performing the actions.

In some implementations, the mathematical models may provide information in addition to a decision whether or not to dispatch a technician and/or one or more actions to be performed. For example, the mathematical models may provide some explanation of what caused the decision or selection made by the model.

In some implementations, the mathematical models may indicate which of the input features were influential in determining the output of the model (e.g., a decision, selection, or output scores). A feature may be influential if changing the feature would significantly change the output the model. For example, if changing a boolean feature (e.g., from true to false) does not significantly change the model output, then that boolean feature was not influential. If the changing the boolean feature significantly changes the model output, then the boolean feature is influential. Similarly, other types of features (e.g., real values) may be changed to determine the impact of a change of the feature on the model output. For example, if changing a real-valued feature by a small amount significantly changes the model output, then the real-valued feature is influential, and if changing a real-valued feature by large amount does not significantly change the model output, then the real-valued feature is not influential.

After determining one or more features that were influential in the model output, information about the influential features may be provided to a person, such as the customer making the request, the CSR assisting the customer, and/or a technician that is dispatched to assist a customer. The influential features may provide a person with a better understanding of why the mathematical model made the corresponding decision or selection. The information about the influential features may also help any of the customer, CSR, or technician resolve the problem, or allow any of them to further investigate and perhaps change the customer support request or make a new customer support request.

Any appropriate techniques may be used to determine which features were influential. In some implementations, a wide-and-deep neural network, LIME (local interpretable model-agnostic explanations) techniques, or self-attentive models may be used as described in greater detail below.

In some implementations, a wide and deep neural network may be used to determine which features were influential. A wide model may be any model that facilitates determining influential features, such as a linear model. A deep model may be any model with strong modeling capabilities, such as a multi-layer perceptron. The combination of the two models may provide the benefits of both models. The wide and deep neural network may process a feature vector, x, and output a classification decision and information indicating which features were influential. An example of a wide and deep neural network for a dispatch model that outputs a single classification decision is now described.

A linear model may be implemented using a cross-product transformation of the features. For example, a cross-product feature transformation may be implemented as:

$${φ}_{j} ( x ) = {\prod }_{i = 1}^{d} {x}_{i}^{{c}_{ij}}$$

where cᵢⱼ is 0 or 1 and d is the number of features in x. A vector ϕ(x) may be created by combining each of the ϕⱼ(x). The linear model may be computed as

y_{wide}=w_{wide}^{T}[x,ϕ(x)]+b_{wide}

where y_{wide} is an output score relating to whether to dispatch a technician and w_{wide} and b_{wide} are model parameters.

A deep model may be implemented as

y_{deep}⁰=x

y_{deep}^{l}=σ(W^{l}y_{deep}^{l-1}+b^{l}) for l=1. . . n

y_{deep}=w_{deep}^{T}y_{deep}ⁿ+b_{deep}

where W^{l}, b^{l}, w_{deep}^{T}, and b_{deep} are model parameters, σ is a non-linear function such as the hyperbolic tangent or rectified linear unit, and y_{deep} is an output score relating to whether to dispatch a technician.

The combination of the wide and deep models may be implemented as

p=σ(y_{wide}+y_{deep})

where p is a score relating to whether to dispatch a technician and σ is the logistic sigmoid function. To determine whether to dispatch a technician, the score p may, for example, be compared to a threshold.

The parameters of the wide model may then be used to determine the influential features. For example, an element-wise product of w_{wide}^{T} and [x, ϕ(x)] may be performed, and the largest values of the element-wise product may indicate the features or combination of features that were the most influential in determining the model output. For example, large positive values may indicate influential features in determining to dispatch a technician and large negative values may indicate influential features in determining not to dispatch a technician.

Wide and deep models may also be used for an analysis model that produces scores for multiple possible actions. For example, the vectors w_{wide} and w_{deep} may be replaced with matrices with a row for each possible class and σ may be replaced with the softmax function.

In some implementations, LIME techniques may be used to determine which features were influential. With LIME techniques, a model may be locally approximated by a linear model and the linear model may be used to determine which features were influential for a given input feature vector x. An example of a LIME technique for a dispatch model that outputs a single classification decision is now described.

Let f represent the dispatch model, which may be any appropriate model, such as a neural network, and let x be a feature vector processed by the dispatch model to determine whether to dispatch a technician. The feature vector x is approximated by a binary version of the feature vector denoted as z (all elements are 0 or 1). Any appropriate techniques may be used to binarize a feature vector, such as by using 1-hot encoding or binning continuous-valued features into discrete values. The linear model may be implemented as

g(z)=w^{T}z+b

where w and b are parameters of the linear model and z is the binarized feature vector.

The linear model is trained using a corpus of training data, such as the same training data that was used to train the dispatch model. In some implementations, the linear model may be training with a subset of the training data, such as a subset comprising feature vectors that are close to the feature vector currently being processed. The linear model may be trained by minimizing a loss function, such as

$$L ( f , g , {π}_{x} ) = {\sum }_{z , {z}^{′} ∈ Z} {π}_{x} ( z ) {( f ( z ) - g ( {z}^{′} ) )}^{2}$$

$${π}_{x} ( z ) = {e}^{- \frac{{D ( x , y )}^{2}}{{σ}^{2}}}$$

where Z is the training corpus, z is a feature vector from the training corpus, z′ is a binarized version of z, and D is a distance function, such as a Euclidean distance or a cosine distance.

The parameters of the linear model may be determined as

$$w , b = {argmin}_{w , b} L ( f , g , {π}_{x} )$$

The values of w may then be used to determine the influential features. The values of w may be considered to be scores that indicate the influence of the features in x. For example, a number of features having the highest scores in the w vector may be selected as influential or all features having a score above a threshold may be considered to be influential.

In some implementations, it may be desired to impose a sparsity constraint on the vector w so only a specified number of elements are non-zero. Any appropriate techniques may be used to impose a sparsity constraint. For example, a Lasso penalty may be applied or ridge regression may be used to fit the linear model.

LIME techniques may also be used for an analysis model that produces scores for multiple possible actions. For example, a different linear function g may be used for each of the possible actions of the analysis model.

In some implementations, self-attentive models may be used to determine which features were influential. Self-attentive models may transform a feature vector using a matrix of feature embeddings to determine influential features. An example of an attentive model for a dispatch model that outputs a single classification decision is now described.

For a feature vector x, each element of the vector is a feature, and a feature embedding may be computed or obtained for each feature. Where each feature embedding is a vector, the feature embeddings for the features may be combined to create a feature embedding matrix. In some implementations, a feature embedding may be created for each feature that is non-zero. For example, where a feature vector has length n (for n features) and m of the features are non-zero, a feature embedding matrix may be m by n.

Let X denote the feature embedding matrix and Xᵢ the i^{th} row of X and corresponding to the i^{th} feature. A self-attentive model may be used to compute a feature vector z from the feature embedding matrix X as follows:

$${y}_{i} = {w}^{T} σ ( {WX}_{i} + b ) for i = 1 … m$$

$${α}_{i} = \frac{{e}^{{y}_{i}}}{{Σ}_{j} {e}^{{y}_{j}}}$$

$$z = {\sum }_{i = 1}^{m} {α}_{i} {X}_{i}$$

where w, W, and b are parameters of the self-attentive model and a is a non-linear function. In some implementations, multi-head attention may be used and w may be a matrix instead of a vector.

The feature vector z may then be processed by another model to determine whether to dispatch a technician. For example, a logistic regression classifier may be used:

p=σ(u^{T}z+c)

where z and c are parameters of the logistic regression classifier and p is a score relating to whether to dispatch a technician.

After determining whether to dispatch a technician using the score p, the αᵢ may be considered to be scores relating to the influence of a feature and used to determine the influential features. For example, a number of features having the highest scores may be selected as influential or all features having a score above a threshold may be considered to be influential.

Any appropriate techniques may be used to determine which features were influential in a dispatch model or an analysis model in making a decision of selection. After a dispatch model or an analysis model outputs a decision or a selection, features that were influential in determining the model output may be identified. The following are hypothetical examples of determinations of influential features.

One or more mathematical models make a determination to dispatch a technician and repair inside wiring at a customer's house. Using any of the techniques described above, three features are identified as influential: (i) a feature for the number of video devices in the house with a value of 30, (ii) a feature indicating the health of a network node with a value of 0 (indicating that the network node is operating correctly), and (iii) an intent of the customer support request as determined from text of the request is poor-quality-video. These influential features may be used to confirm that the mathematical models made a correct decision and to assist a technician in preparing for the service call.

One or more mathematical models make a determination to dispatch a technician and repair outside wiring at a customer's house. Using any of the techniques described above, three features are identified as influential: (i) a feature for the location of the customer indicates that the customer lives in a location with frequent storms, (ii) a feature indicating the health of a network node had a value of 0 indicating that the network node is operating correctly, and (iii) an intent of the customer support request as determined from text of the request is all-services-out. These influential features may be used to confirm that the mathematical models made a correct decision and to assist a technician in preparing for the service call. For example, a technician may prepare by bringing a ladder to repair outside wiring.

One or more mathematical models make a determination to not dispatch a technician. Using any of the techniques described above, three features are identified as influential: (i) a feature that indicates that the customer has not paid their bill in three months, (ii) a feature that indicates that services to the customer have been deactivated, and (iii) an intent of the customer support request as determined from text of the request is all-services-out. These influential features may be used to confirm that the mathematical models made a correct decision and to assist a customer service representative in explaining to the customer why his services are not working.

After influential features have been determined, any appropriate techniques may be used to inform a person about the influential features. In some implementations, a person may be provided with a list of influential features, where the list includes for each feature one or more of text describing the feature (e.g., “Location of customer”), a value of the feature (e.g., 100 Main St.), and a score indicating how influential the feature was in determining whether to dispatch a technician and/or selecting one or more actions (e.g., on a scale of 1 to 100).

A report may also be generated using the influential features. In some implementations, a set or library of report templates may be available and a template may be selected using the influential features. For example, a decision tree or rules-based approach may be used to select a template and a report may be generated by inserting information about the influential features (e.g., text describing the feature, a value of the feature, or a score indicating the influence of the feature) may be inserted into placeholder slots of the template to generate a report.

In some implementations, a classifier may be used to generate a report. For example, a classifier may process information about the influential features to select a template from a set or library of templates. A classifier may also be used to determine how and where information about the influential features are inserted into placeholder slots of the selected template. The report generation classifier may be trained using examples of human-generated reports, and any appropriate classifier may be used, such as a support vector machine or a logistic regression classifier.

In some implementations, a report may be created using a generative model. For example, a recurrent neural network may process the influential features and/or one or more hidden states of the model (e.g., a dispatch model or analysis model), such as generating a report word by word or character by character.

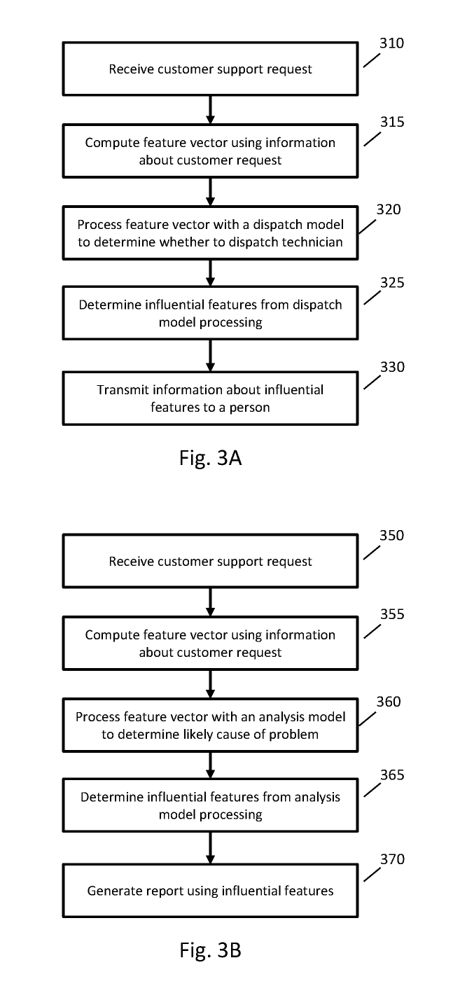

FIG. 3A is a flowchart of an example implementation of identifying influential features for a dispatch model and FIG. 3B is a flowchart of an example implementation of identifying influential features for an analysis model. In FIGS. 3A and 3B, the ordering of the steps is exemplary and other orders are possible, not all steps are required, and, in some implementations, some steps may be omitted or other steps may be added. The process of the flowcharts may be implemented, for example, by any of the computers or systems described herein.

At step 310, a customer support request is received, and at step 315 a feature vector is computed using information about the customer request. At step 320, the feature vector is processed with a dispatch model to determine whether to dispatch a technician. At step 325, one or more features of the feature vector are determined to be influential in the determination of whether to dispatch a technician. At step 330, information about the influential features is transmitted to a person, such as by generating a report and transmitting the report to the person. These steps may be performed using any of the techniques described herein.

At step 350, a customer support request is received, and at step 355 a feature vector is computed using information about the customer request. At step 360, the feature vector is processed with an analysis model to determine one or more actions to be performed to resolve the customer support request. At step 365, one or more features of the feature vector are determined to be influential in the selection of one or more actions. At step 370, information about the influential features is transmitted to a person, such as by generating a report and transmitting the report to the person. These steps may be performed using any of the techniques described herein.

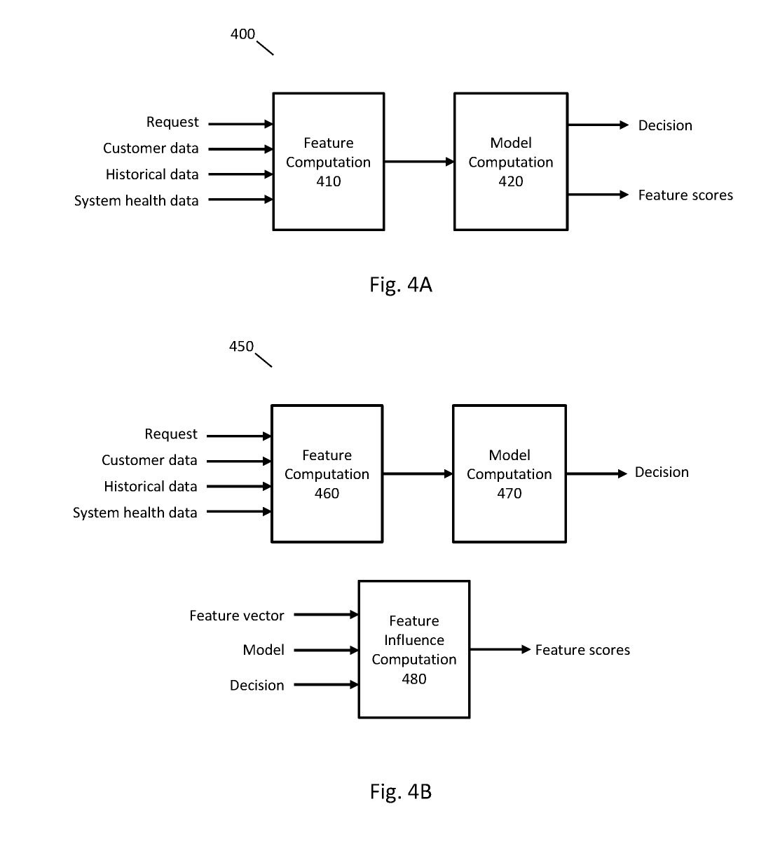

FIG. 4A is an example system 400 for using a model to make a decision or selection by processing a feature vector where the model outputs the decision or selection and also outputs feature scores that indicate the influence of the features of the feature vector. System 400 includes a feature computation component 410. Feature computation component 410 may receive as input any of the information described herein, such as information about a customer request, data about the customer making the request, historical data about the customer or other customers, and system health data relation to the operation of services provided by the company. Feature computation component 410 may process the received information using any of the techniques described herein and output a feature vector. Model computation component 420 may process the feature vector and output a decision (e.g., a decision whether to dispatch a technician) and/or selection (e.g., a selection of one or more actions to be performed). Model computation component 420 may also output feature scores, such as a vector of feature scores where each element of the feature scores vector indicates an influence of the corresponding feature of the feature vector in making the decision or selection. Model computation component 420 may use any appropriate model, such as any of the models described herein.

FIG. 4B is an example system 450 for using a model to make a decision or selection by processing a feature vector where an additional step is performed to determine the influence of the features in of the feature vector. System 400 includes a feature computation component 460 that may be the same as feature computation component 410 or may perform different process (e.g., compute different features). Model computation component 470 may process the feature vector and output a decision (e.g., a decision whether to dispatch a technician) and/or selection (e.g., a selection of one or more actions to be performed). Feature influence computation component 480 may process one or more inputs to output feature scores, such as a vector of feature scores where each element of the feature scores vector indicates an influence of the corresponding feature of the feature vector in the making the decision or selection by model computation component 470. Feature influence computation component 480 may receive as input any appropriate information, such as the feature vector computed by feature computation component 460, the model used by model computation component 470, and the decision or selection made by model computation component. Feature influence computation component 480 may use any appropriate techniques, such as any of the techniques described herein.

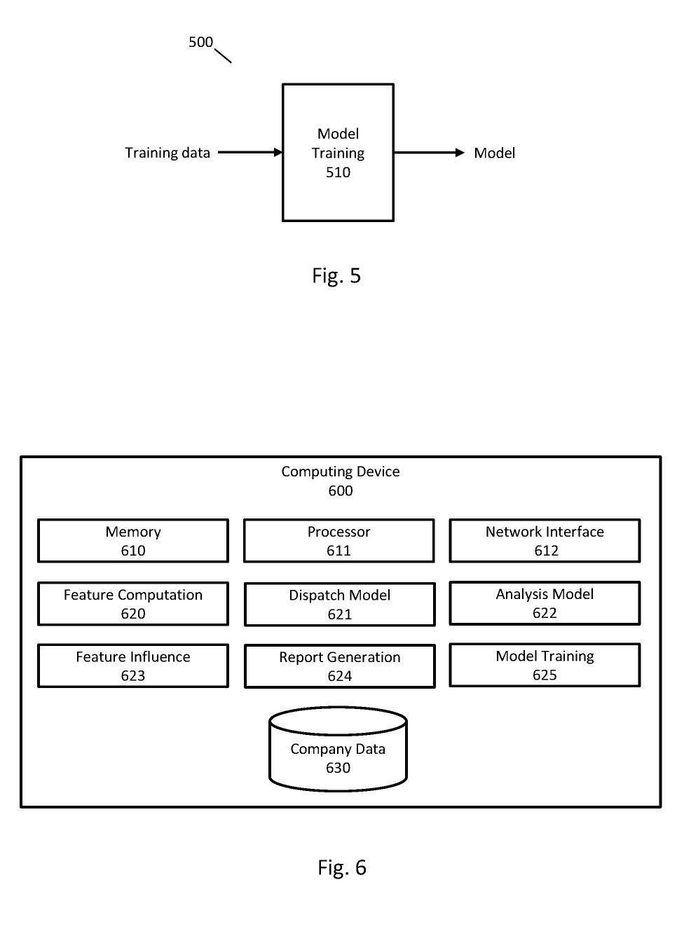

FIG. 5 is an example system 500 for training a dispatch model or an analysis model. Model training component 510 may receive as input any appropriate data for training a model, such as any of the data described herein. Model training component may train a model, such as any of the models described herein, using any appropriate techniques, such as back propagation, stochastic gradient descent, maximum likelihood estimation, or loss minimization.

FIG. 6 illustrates components of one implementation of a computing device 600 for implementing any of the techniques described above. In FIG. 6, the components are shown as being on a single computing device 600, but the components may be distributed among multiple computing devices, such as a system of computing devices, including, for example, an end-user computing device (e.g., a smart phone or a tablet) and/or a server computing device (e.g., cloud computing).

Computing device 600 may include any components typical of a computing device, such as volatile or nonvolatile memory 610, one or more processors 611, and one or more network interfaces 612. Computing device 600 may also include any input and output components, such as displays, keyboards, and touch screens. Computing device 600 may also include a variety of components or modules providing specific functionality, and these components or modules may be implemented in software, hardware, or a combination thereof. Below, several examples of components are described for one example implementation, and other implementations may include additional components or exclude some of the components described below.

Computing device 600 may have a feature component 620 that computes a feature vector for a customer support request. Computing device 600 may have dispatch model component 621 that determines whether to dispatch a technician by processing a feature vector with a dispatch model. Computing device 600 may have an analysis model component 622 that selects one or more actions to be performed to resolve a customer support request. Computing device 600 may have a feature influence component 623 that determines an influence of features in processing the features to make a decision or selection. Computing device 600 may have a report generation component 624 that generates a report using one or more of a dispatch decision, one or more selected actions, and information about influential features. Computing device 600 may have model training component 625 that trains a dispatch model or analysis model using training data.

Computing device 600 may include or have access to various data stores. Data stores may use any known storage technology, such as files or relational or non-relational databases. For example, computing device 600 may have a company data store 630 that stores information about the company and customers that may be used for computing feature vectors and training models.

The techniques described above may be combined with any of the techniques described in U.S. patent application Ser. No. 15/254,008 filed on Sep. 1, 2016, which is herein incorporated by reference in its entirety for all purposes. For example, any of the techniques described herein may be provided as part of a third-party semantic processing service whereby a third party provides semantic processing services to a company to assist the company in providing customer service to its customers.

The methods and systems described herein may be deployed in part or in whole through a machine that executes computer software, program codes, and/or instructions on a processor. “Processor” as used herein is meant to include at least one processor and unless context clearly indicates otherwise, the plural and the singular should be understood to be interchangeable. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A computer-implemented method for responding to a customer support request:
receiving first text of a first customer support request from a first customer, wherein the first customer receives a service from a first company;
computing a first feature vector for input into a mathematical model, wherein the first feature vector comprises (i) features computed using the first text of the first customer support request and (ii) features relating to one or more of an operational status of the service, previous customer support requests of the first customer, information obtained from an account of the first customer, or customer support requests received from other customers;
determining to dispatch a technician to assist in resolving the first customer support request by processing the first feature vector with a dispatch model, wherein the dispatch model is a mathematical model configured to process a feature vector and output a decision regarding dispatch of a technician;
selecting a first action from a plurality of possible actions by processing a second feature vector with a first analysis model, wherein the first analysis model is a mathematical model configured to process a feature vector and output values indicating an action to be performed in response to a customer support request, and wherein the second feature vector comprises a feature vector for input into a mathematical model, and further comprises the first feature vector or another feature vector;
transmitting to a first person (i) information about the determination to dispatch a technician to assist in resolving the first customer support request and (ii) information about the selected first action;
receiving second text of a second customer support request from a second customer, wherein the second customer receives the service from the first company;
computing a third feature vector for input into a mathematical model, wherein the third feature vector comprises (i) features computed using the second text of the second customer support request and (ii) features relating to one or more of an operational status of the service, previous customer support requests of the second customer, information obtained from an account of the second customer, or customer support requests received from other customers;
determining not to dispatch a technician to assist in resolving the second customer support request by processing the third feature vector with the dispatch model;
selecting a second action from a plurality of possible actions by processing a fourth feature vector with a second analysis model, wherein the second analysis model is the first analysis model or another mathematical model configured to process a feature vector and output values indicating an action to be performed in response to a customer support request, and wherein the fourth feature vector comprises a feature vector for input into a mathematical model, and further comprises the third feature vector or another feature vector; and
transmitting to a second person (i) information about the determination not to dispatch a technician to assist in resolving the second customer support request and (ii) information about the selected second action.

2. The computer-implemented method of claim 1, wherein the service comprises providing access to the Internet, providing television services, providing telephone services, providing security services, providing electrical services, providing gas services, or providing water services.

3. The computer-implemented method of claim 1, wherein the first person is the first customer, a technician, or a customer service representative assisting the first customer.

4. The computer-implemented method of claim 1, wherein the first feature vector comprises a feature relating to a location of the first customer.

5. The computer-implemented method of claim 1, wherein the first text of the first customer support request was obtained from a text message received from the first customer or obtained by performing automatic speech recognition on speech of the first customer.

6. The computer-implemented method of claim 1, comprising:
determining that a second feature of the second feature vector was influential in selecting the first action; and
providing information about the second feature to the first person.

7. The computer-implemented method of claim 6, wherein determining that the second feature of the second feature vector was influential in selecting the first action comprises (i) using a wide-and-deep neural network, (ii) approximating the first analysis model with a linear model, or (iii) obtaining a feature embedding for features of the second feature vector.

8. The computer-implemented method of claim 1, wherein:
selecting the second action comprises processing the fourth feature vector with the second analysis model;
the first analysis model selects an action to be performed by a technician; and
the second analysis model selects an action to be performed by a person other than a technician.

9. A system for presenting information about a resource to a user, the system comprising:
at least one server computer comprising at least one processor and at least one memory, the at least one server computer configured to:
receive first text of a first customer support request from a first customer, wherein the first customer receives a service from a first company;
compute a first feature vector for input into a mathematical model, wherein the first feature vector comprises (i) features computed using the first text of the first customer support request and (ii) features relating to one or more of an operational status of the service, previous customer support requests of the first customer, information obtained from an account of the first customer, or customer support requests received from other customers;
determine to dispatch a technician to assist in resolving the first customer support request by processing the first feature vector with a dispatch model, wherein the dispatch model is a mathematical model configured to process a feature vector and output a decision regarding dispatch of a technician;
select a first action from a plurality of possible actions by processing a second feature vector with a first analysis model, wherein the first analysis model is a mathematical model configured to process a feature vector and output values indicating an action to be performed in response to a customer support request, and wherein the second feature vector comprises a feature vector for input into a mathematical model, and further comprises the first feature vector or another feature vector;
transmit to a first person (i) information about the determination to dispatch a technician to assist in resolving the first customer support request and (ii) information about the selected first action;
receive second text of a second customer support request from a second customer, wherein the second customer receives the service from the first company;
compute a third feature vector for input into a mathematical model, wherein the third feature vector comprises (i) features computed using the second text of the second customer support request and (ii) features relating to one or more of an operational status of the service, previous customer support requests of the second customer, information obtained from an account of the second customer, or customer support requests received from other customers;
determine not to dispatch a technician to assist in resolving the second customer support request by processing the third feature vector with the dispatch model;
select a second action from a plurality of possible actions by processing a fourth feature vector with a second analysis model, wherein the second analysis model is the first analysis model or another mathematical model configured to process a feature vector and output values indicating an action to be performed in response to a customer support request, and wherein the fourth feature vector comprises a feature vector for input into a mathematical model, and further comprises the third feature vector or another feature vector;
transmit to a second person (i) information about the determination not to dispatch a technician to assist in resolving the second customer support request and (ii) information about the selected second action.

10. The system of claim 9, wherein the at least one server computer is configured to:
determine that a first feature of the first feature vector was influential in determining to dispatch a technician; and
transmit information about the first feature to the first person.

11. The system of claim 10, wherein the at least one server computer is configured to transmit information about the first feature to the first person by generating a report using the first feature and transmitting the report to the first person.

12. The system of claim 10, wherein the at least one server computer is configured to determine that the first feature of the first feature vector was influential in determining to dispatch a technician by (i) using a wide-and-deep neural network, (ii) approximating the dispatch model with a linear model, or (iii) obtaining a feature embedding for features of the first feature vector.

13. The system of claim 9, wherein the at least one server computer is configured to:
determine that a second feature of the second feature vector was influential in selecting the first action; and
providing information about the second feature to the first person.

14. The system of claim 13, wherein the at least one server computer is configured to determine that the second feature of the second feature vector was influential in selecting the first action by (i) using a wide-and-deep neural network, (ii) approximating the first analysis model with a linear model, or (iii) obtaining a feature embedding for features of the second feature vector.

15. The system of claim 9, wherein the at least one server computer is configured to determine to dispatch the technician using the dispatch model by (i) using a wide-and-deep neural network or (ii) obtaining a feature embedding for features of the first feature vector.

16. The system of claim 9, wherein the first feature vector comprises a feature relating to a location of the first customer.

17. One or more non-transitory computer-readable media comprising computer executable instructions that, when executed, cause at least one processor to perform actions comprising:
receiving first text of a first customer support request from a first customer, wherein the first customer receives a service from a first company;
computing a first feature vector for input into a mathematical model, wherein the first feature vector comprises (i) features computed using the first text of the first customer support request and (ii) features relating to one or more of an operational status of the service, previous customer support requests of the first customer, information obtained from an account of the first customer, or customer support requests received from other customers;
determining to dispatch a technician to assist in resolving the first customer support request by processing the first feature vector with a dispatch model, wherein the dispatch model is a mathematical model configured to process a feature vector and output a decision regarding dispatch of a technician;
selecting a first action from a plurality of possible actions by processing a second feature vector with a first analysis model, wherein the first analysis model is a mathematical model configured to process a feature vector and output values indicating an action to be performed in response to a customer support request, and wherein the second feature vector comprises a feature vector for input into a mathematical model, and further comprises the first feature vector or another feature vector;
transmitting to a first person (i) information about the determination to dispatch a technician to assist in resolving the first customer support request and (ii) information about the selected first action;
receiving second text of a second customer support request from a second customer, wherein the second customer receives the service from the first company;
computing a third feature vector for input into a mathematical model, wherein the third feature vector comprises (i) features computed using the second text of the second customer support request and (ii) features relating to one or more of an operational status of the service, previous customer support requests of the second customer, information obtained from an account of the second customer, or customer support requests received from other customers;
determining not to dispatch a technician to assist in resolving the second customer support request by processing the third feature vector with the dispatch model;
selecting a second action from a plurality of possible actions by processing a fourth feature vector with a second analysis model, wherein the second analysis model is the first analysis model or another mathematical model configured to process a feature vector and output values indicating an action to be performed in response to a customer support request, and wherein the fourth feature vector comprises a feature vector for input into a mathematical model, and further comprises the third feature vector or another feature vector;
transmitting to a second person (i) information about the determination not to dispatch a technician to assist in resolving the second customer support request and (ii) information about the selected second action.

18. The one or more non-transitory computer-readable media of claim 17, wherein the actions comprise:
determining that a first feature of the first feature vector was influential in determining to dispatch a technician; and
transmitting information about the first feature to the first person.

19. The one or more non-transitory computer-readable media of claim 17, wherein the actions comprise:
determining that a second feature of the second feature vector was influential in selecting the first action; and
providing information about the second feature to the first person.

20. The one or more non-transitory computer-readable media of claim 17, wherein determining to dispatch the technician using the dispatch model comprises (i) using a wide-and-deep neural network or (ii) obtaining a feature embedding for features of the first feature vector.

21. The system of claim 9, wherein each feature of each of the feature vectors comprises one of a Boolean value or a numerical value.

22. The computer-implemented method of claim 1, comprising:
computing a score for each feature of the first feature vector indicating the influence of the feature in the decision to dispatch the technician or the selection of the first action;
selecting a first feature using the scores;
generating a report using the first feature, wherein the report includes text corresponding to the first feature; and
transmitting the report to the first person.
